(19) United States
(12) Patent Application Publication
(10) Pub. No.: US 2025/0208433 A1
(43) Pub. Date: Jun. 26, 2025

(54) OPTICAL DEVICE

(71) Applicant: TMRW FOUNDATION IP S.ÀR.L., Luxembourg (LU)

(72) Inventor: Robert Harry BLACK, Wirral (GB)

(21) Appl. No.: 18/396,354

(22) Filed: Dec. 26, 2023

(51) Int. Cl. G02B 30/22; G02B 30/40

(52) U.S. Cl. CPC G02B 30/22; G02B 30/40

(57) ABSTRACT

An optical device, such a lens, or that includes a lens or lenses. The lens or lenses each have integrated therein a prism correction stage and an atoric correction stage. The prism correction stage operates to redirect an image of an object or scene so that the line of sight associated with the eye or eyes of a viewer are directed straight forward towards the lens or lenses, whereby the vergence angle between the eyes is reduced to zero or near zero degrees. The atoric correction stage operates to reshape the image so that the trapezoidal distortion caused by the redirection of the image due to the prism correction stage is at least reduced if not eliminated, and without affecting the reduction of the vergence angle as a result of the redirection of the image by the prism correction stage. In a case where the optical device has two lenses, the prism correction stage and the atoric correction integrated into each lens operate in such a way so as to reduce or eliminate stereopsis and produce, for each eye, an identical, or monoscopic image such that the viewer sees the object or scene at optical infinity.

### BACKGROUND OF THE INVENTION

### Field of the Invention

The following disclosure relates to ophthalmic devices, such as wearable lenses, including contact lenses, implantable lenses, including inlays and onlays and other like devices comprising optical components. More particularly, the disclosure covers exploiting the synoptic effect of a two-dimensional (2D) image, whereby a user can look at the 2D image, through a device covered by this disclosure, and experience increased three-dimensional (3D) depth perception of the 2D image.

### Related Art

Until recently, the lack of appropriate optical machinery restricted the milling and polishing of optical surfaces to spherical and toric shapes. With the advent of Computerized Numerical Control (CNC) machines, the manufacturing of complex optical surfaces, the so-called free-form surfaces, became feasible, creating new possibilities in spectacle and lens design.

A synopter is a device that exploits what is known as the synoptic effect. A synopter may comprise several optical elements. In a simple example, the synopter may include mirrors and a beam splitter. In a relatively more complex example, the synopter may include several different shaped lenses, mirrors, as well as a prism. FIG. 1 is a diagram of a linear binoviewer 5, which is an example of a more complex synopter. Binoviewer 5 has a housing 10. Housing 10 has front opening 15. Incoming light 20 enters the synopter or binoviewer 5 through front opening 15. The light then goes through positive meniscus lens 25 which focuses the light on first C-shaped lens 30. Passing through first C-shaped lens 30 the light diverges, and it continues to second C-shaped lens 35. Second C-shaped lens 35 causes the light to further diverge, and the light continues to negative meniscus lens 40. Negative meniscus lens 40 then focuses the light on beam splitter prism 45, which splits the beam to right mirror 50 and left mirror 65. Right mirror 50 then reflects the light to right plano-concave lens 55. The light exits the binoviewer 5 through right eye lens 60 as right eye beam 80 to enter the right eye (not shown) of a user. Left mirror 65 then reflects the light to left plano-concave lens 70 and the light exits the binoviewer 5 through left eye lens 75 as left eye beam 85 to enter the left eye (not shown) of a user.

From the above it can be seen that a typical synopter or binoviewer, such as the one illustrated in FIG. 1, comprises many optical elements which include 8 lenses, 2 mirrors and at least one prism. This makes the synopter or binoviewer, among other things, bulky, expensive, and heavy. One will readily appreciate how difficult it would be to wear such a device on the bridge of one's nose and on one's face in a spectacle fashion because of its bulkiness and weight. Thus, it is the object of the present invention to mitigate these and other shortcomings associated with conventional synopters or binoviewers.

### SUMMARY OF THE DISCLOSURE

What is provided is a lens, or equivalent thereof, including a lens or lenses that are fitted in frames to be worn, contact lenses and any like optical equipment that can be used in viewing a scene, an object, a display, and the like, and any optical devices including same, that function as a synopter. Nevertheless, for ease of discussion, the description below will refer to a “lens.” The lens having, among other things, the functionality of several optical elements. These optical elements may include lenses, mirrors and prisms. The functionality may be obtained by having a prism correction stage and an atoric correction stage. Although other configurations are conceivable.

The prism correction stage may involve the rotation of the image about a Y-axis (essentially vertical axis) resulting in the line of sight of the user being orientated and directed straight forward. In at least one exemplary embodiment described in detail below, the rotation of the image is in the range of 2.77 degrees.

While the functionality of lens is, as stated above, achieved by a prism correction stage and an atoric correction stage, it will be appreciated by those skilled in the art that in a preferred implementation, these stages are integrated together into a single intervention through a single optical surface which combines the prismatic and atoric corrections.

The atoric correction stage may involve the reshaping of a trapezoidal view of the image into a rectangular view of the image. The above summarized functionality may be supplemented by an additional magnification stage.

What is further provided is a synopter comprising a spectacle frame with two lenses, each lens having, among other things, the functionality of several optical elements. These optical elements may include lenses, mirrors and prisms. The functionality may be obtained by having a prism correction stage and an atoric correction stage. Although, other configurations are possible.

The prism correction stage may involve the rotation of the image about the Y-axis (essentially vertical axis) resulting the line of sight of the user being orientated and directed straight forward. In at least one exemplary embodiment described in detail below, the rotation of the image is in the range of 2.77 degrees.

The atoric correction stage may involve the reshaping of a trapezoidal view of the image into a rectangle view of the shape. The above summarized functionality may be supplemented by an additional magnification stage.

What is provided still further is a method of manufacturing a synopter lens. The method may comprise, for example, calculating the profile of the lens or lenses: determining the surface definition file of the lens or lenses from the lens profile: feeding the surface definition file to a lens manufacturing machine: supplying the lens manufacturing machine with a lens blank: cutting the synopter lens using the lens manufacturing machine from the lens blank. The profile of the lens may include a prism correction stage and an atoric correction stage. The profile of the lens may include an additional magnification stage.

In accordance with one aspect of the present invention, according to the exemplary embodiments described herein, the objectives of the present invention may be achieved by a lens comprising, among other things, a prism correction stage and an atoric correction stage. The prism correction stage redirects an image such that a viewer's line of sight is directed forward towards the lens. The atoric correction stage reshapes the image to reduce or eliminate the trapezoidal distortion due to the prism correction stage.

In accordance with another aspect of the present invention, according to the exemplary embodiments described herein, the objectives of the present invention may be achieved by an optical device comprising, among other things, a first lens and a second lens. The first lens has a first prism correction stage and a first atoric correction stage. The first prism correction stage is configured to redirect an image such that a line of sight associated with a first eye of a viewer is directed forward towards the first lens, and the first atoric correction stage is configured to reshape the image to reduce or eliminate trapezoidal distortion due to the redirection of the image by the first prism correction stage. The second lens has a second prism correction stage and a second atoric correction stage. The second prism correction stage is configured to redirect the image such that a line of sight associated with a second eye of the viewer is directed forward towards the second lens, and the second atoric correction stage is configured to reshape the image to reduce or eliminate trapezoidal distortion due to the redirection of the image by the second prism correction stage.

It will be understood that other aspects of the present invention are conceivable and within the scope and spirit of this disclosure.

### BRIEF DESCRIPTION OF THE DRAWINGS

FIG. 1 shows a diagram of a typical binoviewer or synopter.

FIG. 2 shows a diagram of the converging of the eyes when looking at a screen.

FIG. 3 shows a simplified synopter diagram.

FIG. 4 shows a synopter perception.

FIG. 5 shows a simplified normal vision diagram.

FIG. 6 shows a normal vision perception.

FIG. 7 shows a simplified prism correction diagram.

FIG. 8 shows a prism vision perception.

FIG. 9 shows a simplified atoric correction diagram.

FIG. 10 shows an atoric vision perception.

FIGS. 11(a) and 11(b) illustrate a lens, according to exemplary embodiments of the present invention, prismatically and atorically correcting the view of an object as seen through the right eye of the person viewing an object or scene.

FIG. 12 illustrates various parameters that may be considered in the design and manufacturing of a lens or lenses according to exemplary embodiments of the present invention.

### DESCRIPTION OF EXEMPLARY EMBODIMENTS

Photos and other 2D images, such as photographs, paintings and images on a display screen, are actually 3D. Our normal way of looking at a 2D image is suboptimal. We have two laterally separated eyes, which are useful for providing nearfield stereoscopic depth information. It is most sensitive from approximately 17 cm to 3 m and can distinguish marginal stereoscopic information up to approximately 1 km. Therefore, it can be argued that virtually all content we look at, from a smartwatch to the largest cinema screen (Traumplast Leonberg IMAX) is within this range of stereoscopic sensitivity. This stereoacuity or stereoscopic ability is phenomenal. It is 10× more potent than our existing visual acuity, with an average threshold of 75 nanometers, or 10 seconds of arc. There are also well-known zones of viewing comfort, which are +/−0.3 dioptrespheres.

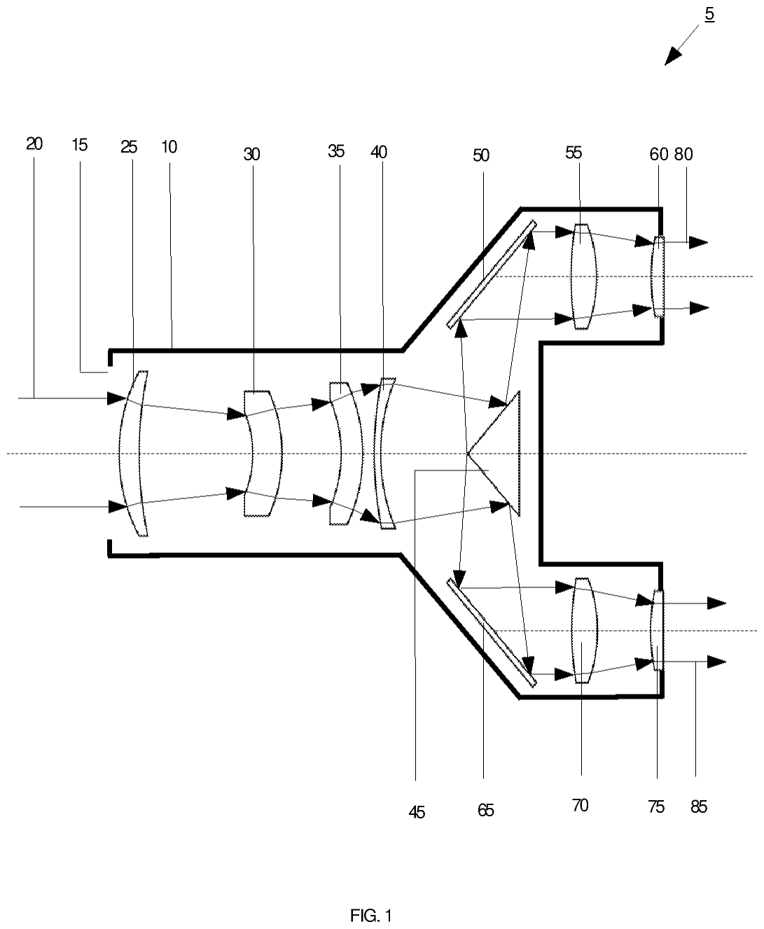

The present invention, according to the exemplary embodiments described herein, is based on the synopter. A synopter is, in principle, designed to take one input beam of light and split it into two parallel output beams, as illustrated in FIG. 1. What the synopter does is remove stereopsis, or the perception of depth produced by the brain due to visually perceiving an object with two eyes. That is, each of a person's two eyes creates different perspectives of the object due to the horizontal separation of two eyes. The brain is capable of perceiving depth based on the difference between these two perspectives.

Stereoscopic vision is, in general, the 3D visual ability of humans viewing an object with two eyes. A single eye creates a two-dimensional image of an object. However, the brain merges the 2D image from each eye and interprets their differences. This results in the direct effect of 3D, or 3D vision (depth perception) through stereoscopic vision quality in humans.

However, this is not the only way the brain generates depth perception. If one is to close one eye and therefore perceives no stereopsis or binocular vision the brain is still able to generate depth perception. That means with only one eye and no stereopsis or binocular vision one is still able to perceive depth perception.

Because a synopter removes stereopsis, the left and the right eye see identical images. This has the effect of giving a monoscopic image. This is stereoscopically defined as optical infinity. People using a synopter with a telescope in astronomy frequently comment on the curvature of the moon even though a telescope has only a single capturing lens. When they look at the moon it looks like a sphere and not like a disc. They can see a parallactic distance between planets and moons of Jupiter. This is because, as explained above, even with no stereopsis or binocular vision one is still able to perceive depth perception.

If we look at a 2D image like a screen of a television, there is a disparity or a difference between what the left and the right eyes see. This is due to the inter-ocular distance between the left and the right eye, as previously explained. However, the 2D television image was initially captured with a single lens camera, so the image itself contains no stereopsis or binocular vision information. This causes a conflict in that, on the one hand, there is a difference between what the left and the right eyes see, and on the other hand, the image contains no stereopsis. Due to this conflict, the brain tells you that you are looking at a flat screen. In the case of a synopter however there is no disparity between what the left and the right eye sees. This is because the left and right eye sees the same image. This is due to the fact that the original image is doubled or duplicated by the prism in the synopter. So, it can be said the synopter removes the conflict and the 2D flat screen image ends up looking more 3D and more detailed.

According to exemplary embodiments of the present invention, the focus is, in general, to replace the synopter, for example, as depicted in FIG. 1 with a simplified device that can be worn on the face of the user, like an ordinary pair of spectacles. By reducing stereoscopic information, optical devices, according to exemplary embodiments of the present invention, increase the perceived depth and realism of a 2D flat screen. This is because our stereo information conventionally gives an extremely robust perception of the spatial location of a flat screen. The typical disparities between the centre and the edge of a flat screen at a standard viewing distance are generally in the range of up to 5-6 degrees. However, our stereo acuity threshold is 75 arc seconds or less. Therefore, we would still be able to perceive the spatial location of a near screen even with 1000× less stereoscopic information. This is a significant problem for convention virtual reality systems, which is why such systems require very high visual capabilities to overcome the stereoacuity threshold.

Optical devices, according to exemplary embodiments of the present invention, present the user with zero stereoscopic information by overcoming both the visual acuity and stereoacuity thresholds. Moreover, these devices are able to do so without source intervention, batteries and post processing. And, unlike cinema-based 3D glasses, these devices are not sensitive to head tilt or viewing distance since, regardless of viewing distance, it is possible to obtain a non-stereoscopic view of the scene by separating the source scene optically by the user's IPD (interpupillary distance).

Furthermore, optical devices, according to exemplary embodiments of the present invention, enable 2D representation media, such as those for art, photography, drawings, computer graphics, films, and the like, which represent 3D information in 2D form, to look more realistic, detailed and stereoscopic. These devices does not necessarily require software intervention, batteries, or source modifications in order to enable the desired effects. Instead, by containing the optical transformation to a single eyeglass lens, the user need only wear the optical device in order to experience significantly enhanced depth. The optimal imagery to show on these devices includes high resolution and high frame rate. Imagery with naturalistic or realistic depth of field is enhanced.

It will be understood, however, that other embodiments and/or applications might involve software, batteries and/or source modifications to provide even greater enhancements. For example, one such application may include egomotion-based head tracking systems, which greatly enhance the perception of depth and are further enhanced by this viewing system.

In at least a first exemplary embodiment, the present invention may be implemented in at least two stages. The first stage being a prism correction stage and the second stage being an atoric correction stage.

The first stage is the prism correction stage. In this stage the vergence angle, or angle between the line of sight from each eye to the object or scene being viewed, is reduced or eliminated by rotating the image, as seen by each eye of the viewer, such that the line of sight associated with each eye is directed forward. As a result, the lines of sight associated with the viewer's eyes are parallel or substantially parallel to each other. However, this introduces trapezoidal distortion which is a symmetrical difference in edge height between the left and right sides of the images as viewed by the left and the right eyes. As previously mentioned, our brains automatically correct for this to some extent. This correction is done by fusion. Fusion is the brain's ability to gather information received from each eye separately and form a single unified image. Fusion is achieved via a combination of sensory and motor fusion. Sensory fusion involves the brain using its existing disparity-led rules to make an assumption and to fuse two images that are within 0.1 degree vertically. Motor fusion involves the eyes actually making a vergence movement to physically correct the alignment of their own left and right images. Vergence movements are disjunctive or disconjugate. Disconjugate movements involve either a convergence or divergence of the lines of sight of each eye to see an object that is nearer or farther away. Conjugate eye movements are when the eyes move in the same direction.

The central argument is that the brain's fusional effort is correlated to the perceived 2D flatness. Resolving this is the purpose of the synoptic effect. When looking at flat 2D images our brains are used to looking at flat images from a regular viewing distance. Even with very strong stereo information coming from the 2D image our brains are instructing us that the image is flat. This is normal and comfortable to us. However, when using a synoptic device, viewers experience a greater level of comfort with less eyestrain.

So, by default people are using up a certain percentage of their visual processing ability just to fuse the image. With this visual processing resource freed up, people report being able to make smaller saccade movements. A saccade movement is a quick, simultaneous movement of both eyes between two or more phases of fixation in the same direction. Humans and many animals do not look at a scene in fixed steadiness. Instead, the eyes move around, locating interesting parts of the scene. A mental, three-dimensional map is constructed that corresponds to the scene.

When scanning immediate surroundings or reading human eyes make saccadic movements and stop several times. Human eyes move very quickly between each stop. The speed of movement during each saccade cannot be controlled. The eyes move as fast as they are able. One reason for the saccadic movement of the human eye is that the central part of the retina which is known as the fovea provides the high-resolution portion of vision. The fovea is very small in humans. It is only about 1-2 degrees of vision, but it plays a critical role in resolving objects. By moving the eye-small parts of a scene can be sensed with greater resolution-eye resources are used more efficiently.

With this visual processing resource freed up people notice finer details, follow perspective lines, track motion more accurately. For example, looking at a 60 hz monitor through a synopter can actually seem more flickery since their brain is processing each individual frame faster, and therefore has more perceptual bandwidth to perceive more frames per second.

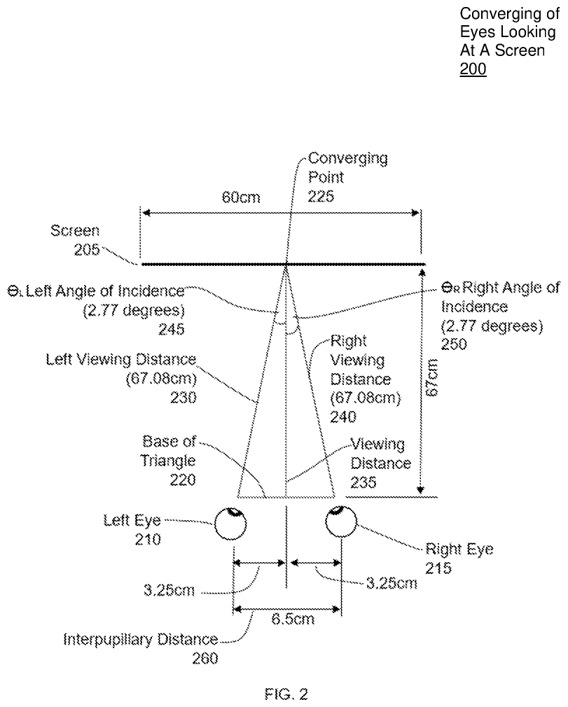

FIG. 2 illustrates the converging of the eyes when looking at a screen 205. In this example, screen 205 has a width of 60 centimeters. At a typical viewing distance 235 from screen 205 may be 67 centimeters. Further, the distance between the eyes is referred to as the interpupillary distance, and in this example, the interpupillary distance 260 is 6.5 centimeters. The base of the triangle 220 is the same as the interpupillary distance 260, or 6.5 centimeters. Viewing distance 235 divides the triangle in two. As can be seen there is a left triangle and a right triangle both of which are equal in size. Viewing distance 235 is at an angle of 90 degrees with the base of triangle 220 and screen 205. The base of the left triangle and the right triangle are equal in length, which is half the interpupillary distance 260, or half of 6.5 centimeters (3.25 centimeters). In the middle of the screen is converging point 225 where viewing distance 235 reaches screen 205. This is where the left eye 210 and the right eye 250 converge. The viewing distance of the left eye 210 to the converging point 225 is left viewing distance 230 which, in this example, is 67.08 cm as shown below. The viewing distance of right eye 215 to the converging point 225 is right viewing distance 240 which is also 67.08 cm. Between the left viewing distance 230 and the viewing distance 235 is left angle of incidence θL 245 which, in this example, is 2.77 degrees as shown by calculation 1 below. Between right viewing distance 240 and viewing distance 235 is right angle of incidence θR 250 which is also 2.77 degrees.

$$tan θ L = ( base of left triangle = half of base triangle 220 ) / ( viewing distance 235 ) \qquad Calculation 1$$

$$tan θ L = ( 3.25 cm ) / ( 67 cm )$$

$$tan θ L = 0.0 \; 485$$

$$θ L = 2.77 deg .$$

As θR is the same size as θL, θR is also 2.77 degrees. Further, since θL and θR equal 2.77 degrees, in this example, this is also the angle that the screen must be rotated for the left and right eyes to view the screen orthogonally at the center.

As for the left and right viewing distances in the example of FIG. 2, calculation 2 below applies.

$$cos θ L = ( viewing distance 235 ) / ( left viewing distance 230 ) \qquad Calculation 2$$

$$left viewing distance 230 = ( viewing distance 235 ) / ( cos θ L )$$

$$\begin{matrix}left viewing distance 230 = 67 cm / ( cos 2.77 ) \\ = 67.08 cm\end{matrix}$$

Because the left viewing distance 230 equals the right viewing distance 240, the right viewing distance 240=67.08 cm.

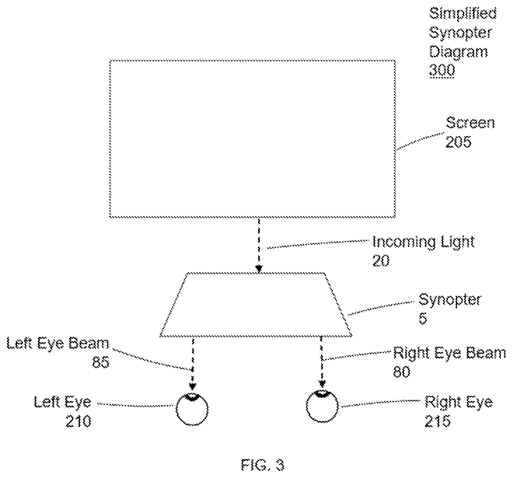

FIG. 3 is a simplified synopter diagram 300 of synopter 5 in FIG. 1. In FIG. 3, screen 205 generates incoming light 20 which enters synopter 5. Incoming light 20 exits synopter 5 as left eye beam 85 and right eye beam 80. Left eye beam 85 then enters left eye 210 and right eye beam 80 enters right eye 215. As illustrated, left eye beam 85 is parallel to right eye beam 80, and left eye 210 and right eye 215 are both parallel orientated relative to each other, where each eye is directed forwards and is straight forward looking.

More specifically, FIG. 3 illustrates the synopter 5 making it so the right eye 215 and the left eye 210 see screen 205 without the right angle of incidence θR and left angle of incidence θL, respectively, which were, in the example of FIG. 3, 2.77 degrees.

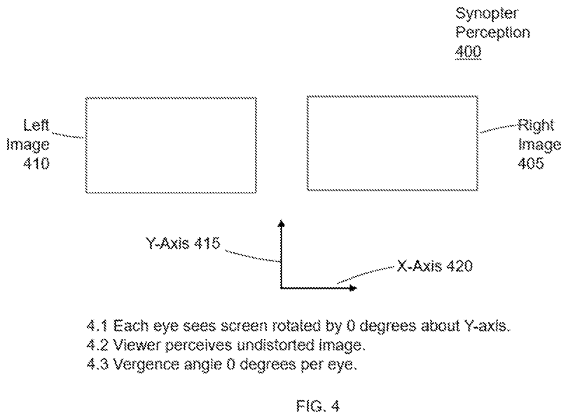

FIG. 4 illustrates the synopter perception 400 of the synopter 5 shown in FIG. 3. The left image 410 in FIG. 4 is seen by left eye 210 in FIG. 3, and right image 405 in FIG. 4 is seen by right eye 215 in FIG. 3. The two images are the same. Also shown is Y-axis 415 and X-axis 420. Each eye sees screen 205 rotated by 0 degrees about the Y-axis 415 because of the synopter 5. The vergence angle is 0 degrees per eye, and the viewer sees an undistorted image. The vergence angle indicates the rotation of the eyes about the Y-axis 415. Generally, as an object on which the eyes focus comes closer, the vergence angles of the eyes increase as the eyes turn towards each other. As the object moves further away from the eyes the vergence angle of the eyes decrease as the eyes turn away from each other. For example, in FIG. 2 the vergence angle of the eyes is 2.77 degrees, the same as the angle of incidence 245 and 250.

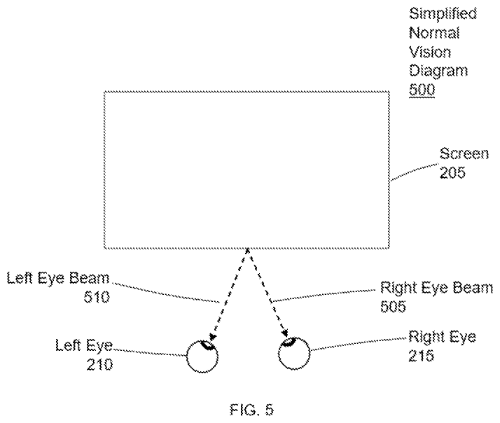

FIG. 5 illustrates a simplified, normal vision diagram 500. Right eye beam 505 is directed from screen 205 towards right eye 215 at an angle. Left eye beam 510 is directed from screen 205 towards left eye 210 at an angle. As illustrated, left eye 210 and right eye 215 converge inwards towards screen 205. FIG. 5 is essentially a simplified version of FIG. 2. The vergence angle of the eyes in FIG. 2 is the same as the angles of incidence θL 245 and θR 250 in FIG. 2, both of which are 2.77 degrees in the example of FIG. 2.

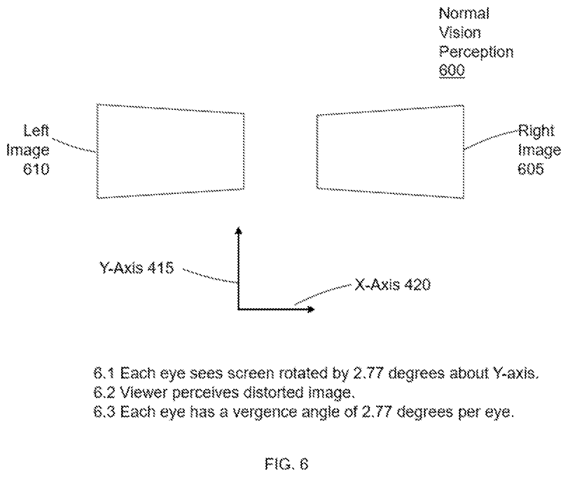

FIG. 6 illustrates the normal vision perception 600 of FIG. 5. In FIG. 6, the screen 205 as perceived is left image 610 seen by left eye 210 and right image 605 seen by right eye 215. Both left image 610 and right image 605 are trapezoidal in shape. Also shown in FIG. 6 is Y-axis 415 and X-axis 420. Each eye (210, 215) sees screen 205 rotated by the respective angles of incidence, θR or θL, of 2.77 degrees about the Y-axis 415, according to the example shown in FIG. 2. The viewer therefore perceives a distorted image in a trapezoidal shape. Each eye has a vergence angle of 2.77 degrees.

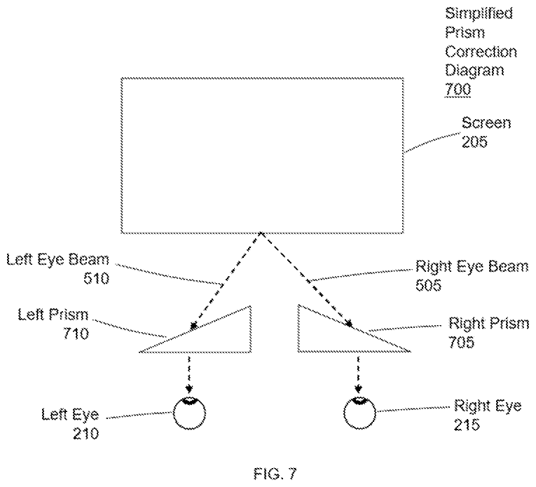

FIG. 7 illustrates a simplified prism correction diagram 700. In FIG. 5, left eye beam 510 and right eye beam 505 are directed at an angle from screen 205 towards the left eye 201 and the right eye 215, respectively. However, in FIG. 7, left eye beam 510 is directed towards left prism 710 (i.e., generally in a straight forward direction towards left prism 710 itself). Left prism 710 bends left eye beam 510 at an angle towards left eye 210. Left eye beam 510 now enters left eye 210 with the line of sight associated with the left eye 210 now orientated and directed straight forward. Similarly right eye beam 505 is directed towards right prism 705 (i.e., generally in a straight forward direction towards right prism 705). Right prism 705 bends right eye beam 505 at an angle towards right eye 215. Right eye beam 505 now enters right eye 215 with the line of sight associated with the right eye 210 now directed and orientated straight forward. Left eye 210 and right eye 215, and more particularly, the lines of sight associated with the left and right eyes 210 and 215 are now directed parallel as in FIG. 3, with no convergence angle there between.

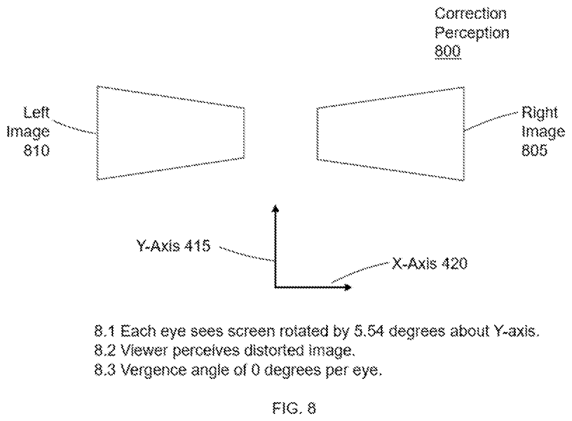

FIG. 8 illustrates a prism correction perception 800. It is, in general, what a person perceives in FIG. 7. As shown in FIG. 8, left image 810 is what left eye 210 is seeing of screen 205 in FIG. 7, and right image 805 is what right eye 215 is seeing of screen 205 in FIG. 7. FIG. 8 also illustrates Y-axis 415 and X-axis 420. When compared to FIG. 5, the addition of left prism 710 and right prism 705 in FIG. 7 beneficially removes the convergence angle between left eye 210 and right eye 215 in FIG. 5. However, the removal of the convergence angle comes at a cost of introducing a further rotation of screen 205. Using the exemplary values and calculations above, the additional rotation is 2.77 degrees. This results in a total rotation of 5.54 degrees as perceived by each eye. Thus, left image 810 and right image 805 are perceived as rotated by 5.54 degrees in total about the Y-axis. The viewer, therefore, would perceive a distorted image, although the vergence angle is beneficially removed (i.e., 0 degrees).

What now remains to be done in accordance with the at least one exemplary embodiment is to remove the aforementioned distortion. To do this, the trapezoidal shape of left image 810 and right image 805 must be adjusted by making the converging or tapering top and bottom edges parallel so that the trapezoidal shape is transformed dimensionally into a rectangle such as the left image 410 and right image 405 in the synopter perception 400 of FIG. 4. This brings us to the second stage of the at least one exemplary embodiment.

The second stage, as previously mentioned, is an atoric correction stage. As previously stated, in a preferred implementation, both the atoric correction of the second stage and the prism correction of the first stage are implemented together in a single intervention on a single lens surface. However, it will be understood that other implementations are conceivable and within the scope of the present invention.

Conventionally, it was only possible or cost effective to manufacture toric lenses. Toric lenses have the shape of a torus with one side cut off. An atoric-shaped lens is a lens that is not in the shape of a torus, and may be referred to as a freeform lens.

As discussed in detail above, the first stage, i.e., the prism correction stage, removes the vergence angle, but causes a trapezoidal distortion by introducing an additional rotation of the left and right images for a total rotation in the range of 5.54 degrees per eye, based on the exemplary values and calculations provided above. The correction of the second stage is an inverse action that keeps the centers of the left and right image separated by the IPD (interpupillary distance) so that the vergence angle remains zero and the left and right eyes remain parallel with each other. This inverse action results in an optical expansion of the shorter vertical side of each (right and left) trapezoidal image, so the shorter, now expanded vertical side matches the opposite side in height, and results in the upper and lower edges of both right and left images being parallel to each other. According to the at least first exemplary embodiment, the correction of the second stage allows the entire visual field to be controlled point by point, enabling the lens/optical device to draw a screen surface discretely to each eye, which visually presents the screen at optical infinity, and with no trapezoidal distortion.

It should be noted that the optical expansion of the shorter edge of each (right and left) trapazoidal image in FIG. 8 reflects what appears to be a rotation of each image about the Y-axis 415. If the height of the taller edge of each image 810 and 805 in FIG. 8 remains the same during this optical expansion of the shorter edge, the Y-axis 415 is essentially coincident with the taller edge of each image, and the rotation of the shorter edge of each image causes the shorter edge of the left and right image to appear closer to the left and right eye, respective. However, it is possible to locate the Y-axis 415 coincident with the shorter edge or anywhere in between the taller edge and shorter edge of each image. As those skilled in the art would readily appreciate, placement of the Y-axis (center of rotation) coincident with the taller edge of each image would result in a positive meniscus expanding inward from the taller edge of each lens. In contrast, placement of the Y-axis (center of rotation) coincident with the shorter edge of each image would result in a negative meniscus expanding outward from the shorter edge of each lens. Placement of the Y-axis (center of rotation) somewhere in between the taller and shorter edges of each image would result in both a positive meniscus expanding inward from the Y-axis 415 and a negative meniscus expanding outward from the Y-axis 415 of each lens. While all implementations are possible, the single positive meniscus implementation (i.e., with the center of rotation at the outer or taller edges) is likely to be the most practical from a manufacturing perspective.

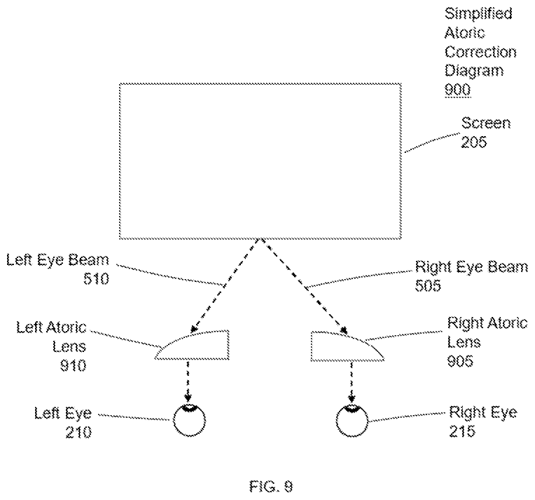

FIG. 9 illustrates a simplified atoric correction diagram 900. In FIG. 9 left eye beam 510 from screen 205 goes to left atoric lens 910. Left atoric lens 910 takes the trapezoidal shape of left image 810 in FIG. 8 and corrects it by reshaping it in a rectangle shape as left image 410 in FIG. 4. This corrected image is then passed on to the left eye 210. The right eye beam 505 follows a similar path. Right eye beam 505 from screen 205 goes to right atoric lens 905. Right atoric lens 905 takes the trapezoidal shape of right image 805 in FIG. 8 and corrects it by reshaping it in a rectangle shape as right image 405 in FIG. 4. This corrected image is then passed on to the right eye 215. As shown, the light beam from left atoric lens 910 to left eye 210 is parallel to the light beam from right atoric lens 905 to right eye 215. Thus, both the left eye 210 and the right eye 215 are parallel and do not converge. As such, they both have a vergence angle of 0 degrees.

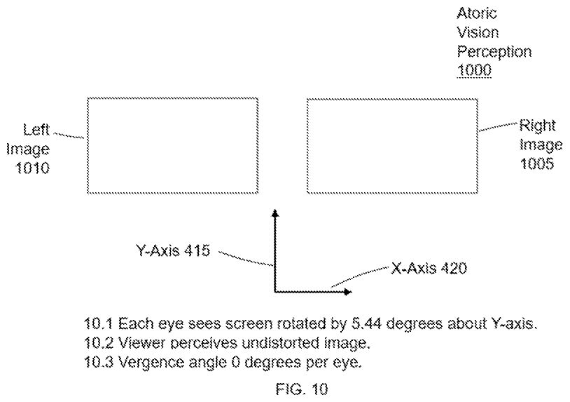

FIG. 10 illustrates an atoric vision perception 1000 as perceived by the left eye 210 and the right eye 215, where left image 1010 is perceived by left eye 210 and right image 1005 is perceived by right eye 215. Also illustrated is Y-axis 415 and X-axis 420. What the left eye 210 and the right eye 215 are seeing is left image 810 and right image 805 in FIG. 8 rotated in an inverse direction from one another, based on the exemplary values and computations presented above. Accordingly, the viewer perceives an undistorted image. The vergence angle between the eyes is 0 degrees. In other words, left image 1010 in FIG. 10 is similar to left image 410 in FIG. 4, and right image 1005 in FIG. 10 is similar to right image 405 in FIG. 4.

In at least a second one or more exemplary embodiments, a magnification stage may be combined with the two stages of the at least one first exemplary embodiment. Magnification may be desirable under certain applications and under certain conditions. For example, a normal field of view for a standard desktop display having a 24 inch screen at a 500 mm viewing distance subtends a visual angle of about 45 degrees horizontally. Doubling the magnification would increase the field of view to 90 degrees, which is more comparable with virtual reality (VR) headsets which are typically in the range of 90-120 degrees of horizontal viewing. Still further, magnification reduction is also contemplated in the at least second one or more exemplary embodiments. If magnification is introduced, it would be preferable to implement the magnification in the same single intervention as the prism and atoric stages.

Now that the disclosure has explained the prism correction and atoric correction stages, the focus now turns to implementing these functions into a lens(es). It should be noted that there is known equipment that can be used to make a lens(es) comprising the functionality of at least the prism and atoric corrective stages in a single intervention, as explained above. One example is the VFT-orbit lens manufacturing machine made by Satisloh.® This machine is known as a freeform lens generator, and it is a fully automated lens surfacing machine. This machine, and other similar machines, are Computerized Numerical Control (CNC) machines. As such, they are fed what is known as a Surface Definition File (SDF), which numerically defines for the machine the surface of the lens that the machine is to manufacture. An explanation will be provided below as to how an exemplary SDF for generating a lens with the prism and atoric correction stages may be generated. In general, the SDF comprises a matrix of values, e.g., 100×100, or 10,000 data points, where collectively, the SDF defines the surface profile of the lens being manufactured. More specifically, each data point in the SDF represents a corresponding point on the surface of the lens, and even more specifically, each data point defines how the freeform lens generating machine is to act on (shape) the corresponding point on the surface of the lens to achieve at least the prism and atoric corrections described above.

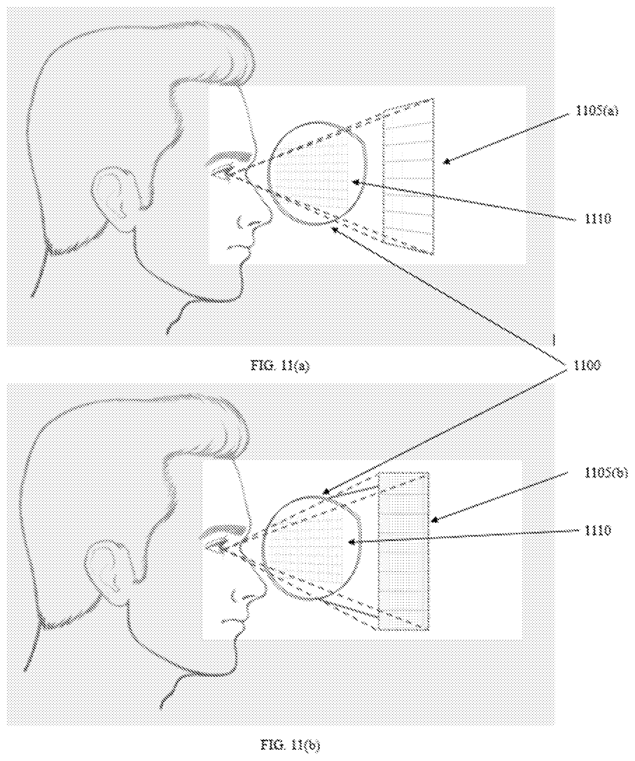

FIGS. 11(a) and 11(b) illustrate a lens 1100, according to exemplary embodiments of the present invention, prismatically and atorically correcting the view of an object 1105 as seen through the right eye of the person in the figures. The grid 1110 on lens 1100 in both FIGS. 11(a) and 11(b) represents the surface of lens 1100 as shaped by the freeform lens generating machine, based on the SDF matrix of data points, such that lens 1100 comprises the functionality of a prism correction stage and an atoric correction stage, as described above. FIG. 11(a) specifically illustrates the effect of the prism correction stage only, whereby object 1105 would be viewed similar to right image 805 in FIG. 8, with no atoric correction stage. FIG. 11(b), however, is intended to illustrate the added effect of the atoric correction stage in conjunction with the prism correction stage, whereby object 1105 is viewed similar to image 205 in FIG. 9. One skilled in the art will understand, of course, that the person in FIGS. 11(a) and 11(b) does not see object 1105(a) in FIG. 11(a). The person only sees object 1105(b) in FIG. 11(b) since the lens 1100 has both the prism and atoric correction stages integrated therein.

As explained above, the profile of the lens surface that achieves at least the prism and atoric correction stages is defined by the SDF. The SDF is, as stated, a matrix of data points, e.g., a matrix of 100×100 data points. The value of each data point is derived based on numerous parameters. While the list of parameters may vary based on any number of factors, such as the type of eyewear and the intended application and/or image(s) to be viewed, the following table represents an exemplary list of parameters that may be used to generate an SDF comprising data points that could, in turn, be used to control the freeform lens generating machine, such as the one referenced above, to shape the surface of a lens so that the thickness and curvature of the lens causes the lens to have the functionality of at least a prism correction stage and an atoric correction stage.

TABLE 1

| Ref. | Parameter | Category | Function |
|---|---|---|---|
| a | Freeform Surface | Lens Design | Choosing whether correction |
| | | | applies to front or rear surface |
| b | Front Surface | Lens | Curvature of initial lens blank |
| | Radius | Property | front edge |
| c | Rear Surface | Lens | Curvature of initial lens blank |
| | Radius | Property | rear edge |
| d | Screen (object) | Screen | Width of object |
| | Width | | |
| e | Screen (object) | Screen | Height of object |
| | Height | | |
| f | Screen (object) | Screen | Distance front of lens to |
| | Distance | | object |
| g | Inter-pupillary | Viewer | Distance between viewer's |
| | distance (IPD) | | eyes |
| h | Magnification | Lens Design | Spherical dioptre correction/ |
| | | | focus/magnification |
| i | Wedge Width | Lens | Horizontal with of lens curve |
| | | Physical | surface |
| j | Wedge Height | Lens | Vertical height of lens curve |
| | | | surface |
| k | Wedge Center | Lens | Thickness of the midpoint of |
| | Thickness | | the lens |
| l | Number of X | Lens Design | Number of horizontal bins/ |
| | Points | | subsections of lens |
| m | Number of Y | Lens Design | Number of vertical bins/ |
| | Points | | subsections of lens |
| n | Wedge Refractive | Lens | Refractive index of plastic |
| | Index | | polystyrene polymer |
| o | Eye Distance | Viewer | Distance between eye and rear |
| | | | lens surface |
| p | Number of SDF | Lens Design | Number of points specified |
| | X Points | | for CNC machine |
| q | Number of SDF Y | Lens Design | Number of points specified |
| | Points | | for CNC machine |
| r | SDF File | Output | Name of the file containing |
| | | | the SDF lens data |
| s | Pantoscopic | Frame | Slope of from viewers face |
| | Angel | Design | to frames |
| t | Pantoscopic Tilt | Frame | Slope of the lens as set within |
| | | Design | the frames |
| u | Eye Height | Frame | Vertical offset for optical |
| | | Design | center |

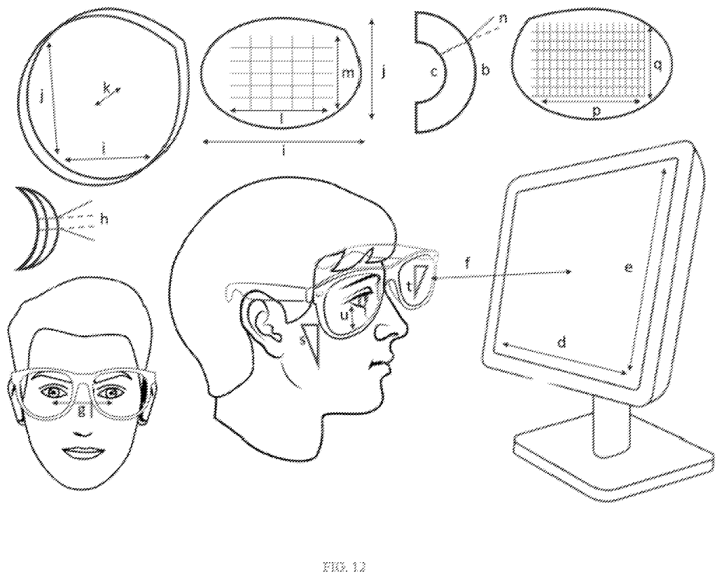

FIG. 12 graphically illustrates the exemplary parameters, a through u, in Table 1 above. Some of these parameters require further explanation, while others may be obvious to those skilled in the art. For ease of explanation, the parameters are grouped based on their respective purposes.

A first group (Group I) includes those parameters that define the rear surface of the lens relative to the eye of the viewer in an x, y, z coordinate space. These parameters are important because they are used to align the eye of the viewer with the center of the lens. The parameters that make up Group I are parameters {o, s, t, u, g}. Parameter o represents the distance from the eye to the rear surface of the lens. It is not shown in FIG. 12, but it should be obvious given the description. In a preferred embodiment, the value of parameter o should be accurate to within a few millimeters (mm) to avoid lens distortion. Parameter s represents the Pantoscopic Angle, or angle between the facial plane of the viewer and the frame holding the lens. The value of this parameter may be estimated based on various factors such as the shape of the viewers face and ethnicity. Parameter t represents the Pantoscopic Tilt, or the angle of the lens as set within the frame. This is a relatively important parameter that is intended to make sure the lens is vertically situated. Parameter u represents the vertical position of the viewer's eye relative to the center of the lens, and it insures the lens is vertically centered. Last, in Group I, is parameter g. Parameter g reflects the inter-pupillary distance, or the distance between the viewer's eyes. This parameter should also be accurate to within a few mm.

As stated above, the list of parameters may vary based on various factors, such as the type of eyewear. In FIG. 12, the eyewear illustrated is a pair of glasses. However, the present invention is not limited to glasses, as previously stated. If the eyewear were contact lenses, it will be appreciated that the parameters in Group I may be different than those described above.

The second group of parameters, or Group II, characterize the relationship between the front and back surfaces of the lens. The parameters that make up Group II are {c, b, n, i, j, k}.

First, parameters c, b and n relate to the characteristics of the un-processed lens or pre-cut lens blank. Specifically, parameter c represents the radius of the rear surface of the pre-cut lens. Parameter b represents the radius of the front surface of the pre-cut lens. It will be appreciated that these two radius values define the curvature of the rear and front surfaces of the pre-cut lens. Parameter n represents the refractive index of the lens.

The second set of parameters that make up Group II includes parameters {i, j, k}. These parameters represent certain dimensions of the lens after it has been initially cut, although not yet shaped to include the prism corrections and atoric corrections. As shown in FIG. 12, parameter i is the overall width, or horizontal length of the curved surface of the lens. Accuracy should be within a few mm. Parameter j is the overall height, or vertical length of the curved surface of the lens. Parameter i and j should be accurate to within a few mm. Parameter k represents the thickness, or depth front to back, at the midpoint of the lens.

The next group of parameters, or Group III, relates to an interim processing step(s), now that the lens has been initially cut. In general, this interim processing step(s) involves dividing the lens surface into a plurality of regions. Group III comprises parameters {l, m}. In FIG. 12, it can be seen that parameter l represents the number of regions or points along a horizontal (x) direction of the lens surface. It follows that parameter m represent the number of regions or points along a vertical (y) direction of the lens surface for each horizontal region. Thus, the surface of the lens has been divided into a plurality of x,y regions, or points, as illustrated in FIG. 12. It will be appreciated by those skilled in the art that the number of regions or points, and thus the values for parameters l and m may vary based on the degree of precision required by the application. Military applications, for example, may require a much higher degree of precision than commercial applications. As such, it can be expected that the surface of a lens for a military application would be divided into a much higher number of regions or points. It will also be understood that the complexity of shaping the surface of the lens increases with the number of regions or points.

The Group IV parameters include parameters {p, q}. These parameters are used in completing the interim processing step(s) in that they further divide the surface of the lens into additional regions. More specifically, each of the regions defined by parameters l and m are further divided into a number of smaller regions. Thus, for example, if each of the regions defined by parameters l and m are further divided by five (5) points in the vertically (y) direction and five (5) points in the horizontally (x), then each of the regions defined by parameters l and m are divided into twenty-five (25) smaller regions or points. Parameter p represents the value of parameter l multiplied by the number of additional divisions of each region in the horizontal (x) direction, while parameter q represents the value of parameter m multiplied by the number of additional divisions of each region in the vertical (y) direction. In the example mentioned above, it was said that the SDF may comprise a matrix of 100×100 data points. In this example, the value of parameter p would be 100, and the value of parameter q would be 100. The value of parameter l and parameter m would, in this example, be 20, thus resulting in 400 initial regions or points, wherein each of these 400 regions or points are further divided into twenty-five (25) smaller regions. Thus, the surface of the lens would be divided into 100×100 regions, or 10,000 points. Each of these 10,000 points equates to a corresponding data point (p, q) in the SDF.

As will be understood by those of skill in the art, a specific value for each of the data points (p, q), for example, each of the 10,000 data points (p, q) has to be determined. Each of these specific values characterizes the shape and/or thickness of the lens at a corresponding one of the data points (p, q). What is left to explain is how the specific values for the data points (p, q) are determined. Once determined, these specific values, along with the other SDF parameter values can be used to control the freeform lens generating machine to initially cut and ultimately shape the lens so that it comprises at least the prism and atoric correction characteristics according to the exemplary embodiments of the present invention.

Those skilled in the art will further appreciate that there are many different methods and techniques that may be employed to arrive at the specific values that make up the matrix of data points (p, q) in the SDF. Because there are many different method and techniques, it is sufficient to state that the process for deriving the specific values that make up the data points (p, q) in the SDF is a numerical process rather than an analytical process.

In general, the process involves starting with the source image, i.e., the image being viewed which must ultimately be reproduced for each eye independently with little to no distortion as a result of the prismatic and atoric corrections integrated into the lenses. For example, the image may be a rectangular display screen, such as the display screen illustrated in FIGS. 3-10. The reproduced images (i.e., the left image for the left eye and the right image for the right eye) are essentially output images. Knowing the source image and the desired output images, it then becomes a matter determining, for example, by ray tracing each point on the source image to corresponding point on the surface of each lens, what the contour and/or thickness of the lens surface must be to alter the image so that the right eye and the left eye see the source image with as little distortion as is desired or as is necessary. The projection of the source image onto the surface of each lens is referred to herein as a virtual image. It will be understood that the virtual image is itself distorted compared to the source image so that the projection from the surface of the lens to the eye is undistorted by virtue of the integration of the atoric and prismatic corrections. One skilled in the art will understand how, for example, to ray trace the source image, through the virtual image on the surface of each lens, to the eyes of the person viewing the source image, and determine the contour and/or thickness of each point on the surface of the lenses so to achieve the desired output images, which have been prismatically and atorically corrected as shown in FIGS. 7-10. The contour and/or thickness of each point on the surface of the lenses is numerically represented by the plurality of data points (p, q) in the SDF.

The aforementioned process of tracing the source image to a virtual image on the surface of each lens, and then to each output image, and determining the specific values for the plurality of data points (p, q) will typically result in output images that have some level of distortion. Because the starting point in this process was the source image, the process can be thought of as a forward process or procedure. Those skilled in the art will further understand that it is possible and probably prudent to perform an inverse process or procedure, whereby the starting point is the reproduced output images. The process described above is essentially repeated in reverse, resulting in a reduction of the distortion. In some cases, it may be even more prudent, depending on how much distortion can be tolerated given the application, to recursively perform the forward and inverse procedures, where each iteration will further reduce the level of distortion of the output images.

As stated, the specific techniques, methods and/or formulas that might be employed to derive the values for the plurality of data points (p, q) may vary. However, once values are obtained for the SDF parameters, the values can then be used to control the freeform lens generating machine to cut and shape lenses such that the prismatic and atoric corrections are integrated there.

It will be appreciated that the embodiments described above are exemplary. Other embodiments are conceivable that fall within the spirit of the invention. The scope of the invention, however, is defined by the claims that follow.

1. A lens comprising:
a prism correction stage; and
an atoric correction stage,
wherein the prism correction stage redirects an image such that a viewer's line of sight is directed forward towards the lens, and
wherein the atoric correction stage reshapes the image to reduce trapezoidal distortion due to the prism correction stage.

2. The lens of claim 1, wherein the prism correction stage and the atoric correction stage are integrated together in a single intervention.

3. The lens of claim 2, wherein the prism correction stage and the atoric correction stage are integrated together in a single intervention on a single surface of the lens.

4. The lens of claim 1, wherein the prism correction stage is configured to redirect the image by rotating the image about a vertical axis by a number of degrees that relates to interpupillary distance.

5. The lens of claim 1, wherein the atoric correction stage is configured to reshape the image and reduce the trapezoidal distortion.

6. The lens of claim 5, wherein the atoric correction stage is further configured to reshape the image from a three-dimensional rotated rectangle, perceived by the viewer as a two-dimensional trapezoid, to a three-dimensional rotated trapezoid, perceived as a two-dimensional rectangle by the viewer.

7. The lens of claim 1 further comprising a magnification stage.

8. An optical device comprising:
a first lens having a first prism correction stage and a first atoric correction stage, the first prism correction stage configured to redirect an image such that a line of sight associated with a first eye of a viewer is directed forward towards the first lens, and the first atoric correction stage configured to reshape the image to reduce trapezoidal distortion due to the redirection of the image by the first prism correction stage; and
a second lens having a second prism correction stage and a second atoric correction stage, the second prism correction stage configured to redirect the image such that a line of sight associated with a second eye of the viewer is directed forward towards the second lens, and the second atoric correction stage configured to reshape the image to reduce trapezoidal distortion due to the redirection of the image by the second prism correction stage.

9. The optical device of claim 8, wherein the first prism correction stage and the first atoric correction stage are integrated together in a single intervention in the first lens, and wherein the second prism correction stage and the second atoric correction stage are integrated together in a single intervention in the second lens.

10. The optical device of claim 9, wherein the first prism correction stage and the first atoric correction stage are integrated together in a single intervention on a single surface of the first lens, and wherein the second prism correction stage and the second atoric correction stage are integrated together in a single intervention on a single surface of the second lens.

11. The optical device of claim 8, wherein the first prism correction stage and the first atoric correction stage of the first lens together with the second prism correction stage and the second atoric correction stage of the second lens are configured to redirect and reshape the image for the first eye of the viewer and the second eye of the viewer, respectively, so as to reduce stereopsis and cause the image to appear at optical infinity from the perspective of the viewer.

12. The optical device of claim 8,
wherein the first prism correction stage of the first lens is configured to redirect the image by rotating the image in a first direction about a vertical axis by a number of degrees,
wherein the second prism correction stage of the second lens is configured to redirect the image by rotating the image in a second direction, opposite the first direction, about the vertical axis by the number of degrees, and
wherein the number of degrees relates to an interpupillary distance of the first eye and the second eye of the viewer.

13. The optical device of claim 12, wherein the first prism correction stage is configured to rotate the image in the first direction about the vertical axis and the second prism correction stage is configured to rotate the image in the second direction about the vertical axis so as to reduce a vergence angle between the line of sight associated with the first eye of the viewer and the line of sight associated with the second eye of the viewer.

14. The optical device of claim 13, wherein the first prism correction stage is configured to rotate the image in the first direction about the vertical axis and the second prism correction stage is configured to rotate the image in the second direction about the vertical axis so as to reduce the vergence angle between the line of sight associated with the first eye of the viewer and the line of sight associated with the second eye of the viewer to zero degrees.

15. The optical device of claim 13,
wherein the first atoric correction stage of the first lens is configured to reshape the image and reduce the trapezoidal distortion perceived by the first eye of the viewer,
wherein the second atoric correction stage of the second lens is configured to reshape the image and reduce the trapezoidal distortion perceived by the second eye of the viewer, and
wherein the first atoric correction stage of the first lens and the second atoric correction stage of the second lens are configured to reshape the image, respectively, without affecting the reduction of the vergence angle between the line of sight associated with the first eye of the viewer and the line of sight associated with the second eye of the viewer.

16. The optical device of claim 15,
wherein the first atoric correction stage of the first lens is further configured to reshape the image from a three-dimensional rotated rectangle, perceived by the first eye of the viewer as a two-dimensional trapezoid, to a three-dimensional rotated trapezoid, perceived as a two-dimensional rectangle by the first eye of the viewer,
wherein the second atoric correction stage of the second lens is further configured to reshape the image from a three-dimensional rotated rectangle, perceived by the second eye of the viewer as a two-dimensional trapezoid, to a three-dimensional rotated trapezoid, perceived as a two-dimensional rectangle by the second eye of the viewer, and
wherein the reshaped image as perceived by the first eye of the viewer and the reshaped image as perceived by the second eye of the viewer are the same image.

17. The optical device of claim 8, wherein the first lens comprises a first magnification stage and the second lens comprises a second magnification stage.

18. The optical device of claim 17, wherein the first magnification stage and the second magnification stage have the same magnification.
